(19) United States
(12) Patent Application Publication
(10) Pub. No.: US 2021/0237694 A1
(43) Pub. Date: Aug. 5, 2021

(54) Roof module for forming a vehicle roof

(71) Applicant: Webasto SE, Stockdorf (DE)

(72) Inventors: Engelbert HIRSCHVOGEL, Stockdorf (DE); Max HUBER, Stockdorf (DE)

(21) Appl. No.: 17/150,647

(22) Filed: Jan. 15, 2021

(30) Foreign Application Priority Data
Feb. 3, 2020 (DE) 10 2020 102 643.9

(51) Int. Cl. B60S 1/56; G01S 17/931; B60R 11/04; G01S 13/931; B60J 7/16; B60S 1/04

(52) U.S. Cl. CPC B60S 1/566; G01S 17/931; B60R 11/04; G01S 2013/93273; B60J 7/16; B60S 1/0411; G01S 13/931

(57) ABSTRACT

A roof module for realizing a vehicle roof on a motor vehicle, the roof module having a panel component whose outer surface forms at least a portion of the roof skin of the vehicle roof, the roof module having at least one environmental sensor which can send and/or receive electromagnetic signals to detect the vehicle environment. The environmental sensor is mounted on the roof module in such a manner that it can be displaced between an inoperative position and an operative position, the environmental sensor being displaceable between the inoperative position and the operative position by a drive mechanism.

The invention relates to a roof module for forming a vehicle roof according to the preamble of claim 1.

Roof modules of this kind are known from practice. As a separate component, a roof module of this kind can be placed on a vehicle body forming a vehicle body shell. The roof module can be a purely solid roof element which has a transparent portion for forming a panoramic roof, the transparent portion forming a see-through portion. Alternatively, the roof module can have a roof opening system comprising a displaceable lid element by means of which a roof opening can be opened or closed at will. Roof modules of this kind always comprise a roof skin, which forms a visible outer surface of the roof module and part of which can be transparent in order to form the see-through portion and which extends as far as to the roof opening if the roof module has a roof opening system. The roof module is often permanently connected to the roof side beams of the vehicle body when the roof module is in an installation position.

Furthermore, it is known for environmental sensors which allow autonomous or semiautonomous driving of the motor vehicle in question to be disposed on the roof modules. The vehicle environment can be monitored and detected by means of the environmental sensors. Sensor modules are known from the state of the art which are attached on top of the vehicle roof because the vehicle roof is typically the highest point of a vehicle, from where a good view of the vehicle environment is obtainable. However, the sensor modules realized as attachments lead to an appearance of the vehicle that typically does not meet customer demands. Another disadvantage of the sensor modules attached on top of the vehicle roof and having the environmental sensors incorporated in them is that the environmental sensors are permanently exposed to weather conditions in this case. In particular, this can cause the environmental sensors to become covered in ice and, therefore, to be no longer usable. Also, the sensor modules attached on top of the vehicle roof prove disadvantageous in terms of aerodynamics and undesired noise due to wind.

The object of the invention is to provide a new roof module which avoids the disadvantages of the known state of the art as described above.

This object is attained by a roof module according to the teaching of claim 1.

Advantageous embodiments of the invention are the subject matter of the dependent claims.

The roof module according to the invention is characterized by at least one environmental sensor which is mounted on the roof module in such a manner that it is displaceable between an inoperative position and an operative position. The environmental sensor can be motor-displaced between the inoperative position and the operative position or, vice-versa, between the operative position and the inoperative position by means of a drive mechanism depending on the current operating mode of the vehicle. When the drive mechanism deploys the environmental sensor into the operative position, this allows autonomous or semi-autonomous control of the vehicle to be realized. When the environmental sensor is no longer needed, it can be moved into the inoperative position by operation of the drive mechanism. The selective positioning of the environmental sensor in an operative position and/or an inoperative position results in different advantages. For instance, adequate configuration of the inoperative position will lead to an appealing design of the parked vehicle since the environmental sensor no longer necessarily protrudes beyond the vehicle roof when in its inoperative position. The same applies to driving without autonomous or semi-autonomous control, which consequently does not require operation of the environmental sensor. Additionally, pollution of the environmental sensor can be significantly reduced when the environmental sensor is in the inoperative position. Also, the environmental sensor of the parked vehicle will not become covered in ice or snow.

The way in which the displacement of the environmental sensor between its inoperative position and its operative position is constructively realized is basically optional. It can be realized in a particularly simple way by providing a housing having a recess on the roof module. The environmental sensor can be accommodated in said recess. When the environmental sensor has been retracted into the recess, it is in its inoperative position and is protected accordingly by being disposed in the recess. When the environmental sensor is deployed, it reaches its operative position, in which the environmental sensor is capable of monitoring the environment.

Furthermore, when a housing having a recess for disposing the environmental sensor on the roof module is used, it is particularly advantageous if the recess of the housing can be closed with a lid mounted in a displaceable manner. When the environmental sensor is in its inoperative position in the recess, the lid can close the recess in order to prevent humidity and dirt from entering the housing. Moreover, the closed lid significantly improves the appearance of the vehicle roof once the environmental sensor has been disposed in its inoperative position. When the environmental sensor is moved into its operative position, the lid above the recess can be opened. With a view to a particularly appealing visual appearance of the vehicle roof, it is advantageous if the sensor housing is disposed underneath the roof skin. The lid of the sensor housing is to be designed in such a manner that the lid forms a portion of the roof skin when the environmental sensor is in the inoperative position. As a result, a closed surface is formed on the roof skin of the vehicle roof when the environmental sensor is disposed in its inoperative position.

The manner in which the lid is mounted in a displaceable manner on the roof module is basically optional. It is particularly advantageous if the lid is mounted in a pivotable manner on the roof module, the pivot axis extending in the plane of the roof skin. In this way, a closed surface is formed on the roof skin of the vehicle roof by simple means when the lid pivots back.

Pivot drives are particularly suitable as a drive mechanism in order to realize a particularly simple and robust drive for displacing the environmental sensor between the inoperative position and the operative position.

As an alternative to pivot drives, lifting drives, in particular scissor lifting drives, can be used as the drive mechanism. Lifting drives allow long displacement paths between the inoperative position and the operative position to be realized in order to achieve a monitoring position as high as possible in the operative position.

When operating the environmental sensor to realize autonomous or semi-autonomous operation of the vehicle, the outer surface of the environmental sensor may become polluted, such as by dirt particles, insects or droplets. Pollutions of this kind can disrupt operation of the environmental sensor and result in termination of the semi-autonomous or autonomous operation of the vehicle. A wiper element by means of which a portion of the outer surface of the environmental sensor is wiped can be disposed in the sensor housing in order to be able to remove pollutions of this kind without manual interference.

The constructive design of the wiper element is basically optional. A particularly cost-efficient and simple variation is achieved when the wiper element is fixed in the sensor housing and is in contact with the portion to be wiped of the outer surface of the environmental sensor. The effective motion needed to wipe the outer surface of the environmental sensor can be realized by displacing the sensor module between its operative position and its inoperative position and, vice-versa, between its inoperative position and its operative position. In other words, this means that the fixed wiper element wipes the outer surface when the environmental sensor is retracted and deployed. To avoid excessive heating of the environmental sensor and to prevent negative effects of weather conditions, such as icing, the environmental sensor may have to be cooled or heated. To realize this in a simple manner, a heating means and/or a cooling means by means of which the environmental sensor is heated and/or cooled can be provided in the sensor housing.

The type of environmental sensor provided in a displaceable manner on the roof module is basically optional. Preferably, it may be a LiDAR sensor and/or a radar sensor and/or a camera sensor and/or a multi-camera sensor and/or another type of sensor using electromagnetic radiation.

Furthermore, with a view to effective cleaning of the environmental sensor, it is advantageous if a cleaning nozzle by means of which a cleaning fluid can be sprayed onto the outer surface of the environmental sensor in order to clean it is disposed in the sensor housing.

To avoid uncontrolled draining of the cleaning fluid after it has been sprayed onto the environmental sensor, it is particularly advantageous if a drain through which the cleaning fluid is discharged from the sensor housing is provided in the sensor housing. When the environmental sensor is cleaned while it is in its operative position, uncontrolled leaking of the cleaning fluid may occur after the actual cleaning process. In particular, the cleaning fluid may enter the vehicle interior through an open roof opening. A method of operating the roof module is proposed to avoid this undesired effect. In said method, the environmental sensor is moved into its inoperative position prior to the actual cleaning, and the lid above the recess the sensor housing is closed. Only then, i.e., once the recess with the environmental sensor located therein has been closed, the cleaning fluid is discharged through the cleaning nozzle. By closing the lid above the recess, uncontrolled leaking of the cleaning fluid is precluded. Instead, the cleaning fluid can be discharged in a controlled manner through the drain in the sensor housing.

In particular, the roof module according to the invention is part of a passenger vehicle, but it can also be used in a utility vehicle, which is realized as a small bus, such as what is referred to as an autonomously driving people mover, as a delivery vehicle or as a tractor unit of a heavy-goods vehicle. A use in rail-bound or water-bound vehicles is possible, as well.

The invention also relates to a motor vehicle comprising a roof module of the kind described above. The motor vehicle can be equipped with an electric drive and/or a combustion engine and basically be any type of road-bound, rail-bound or water-bound vehicle.

An embodiment of the invention is schematically illustrated in the drawings and will be explained as an example below.

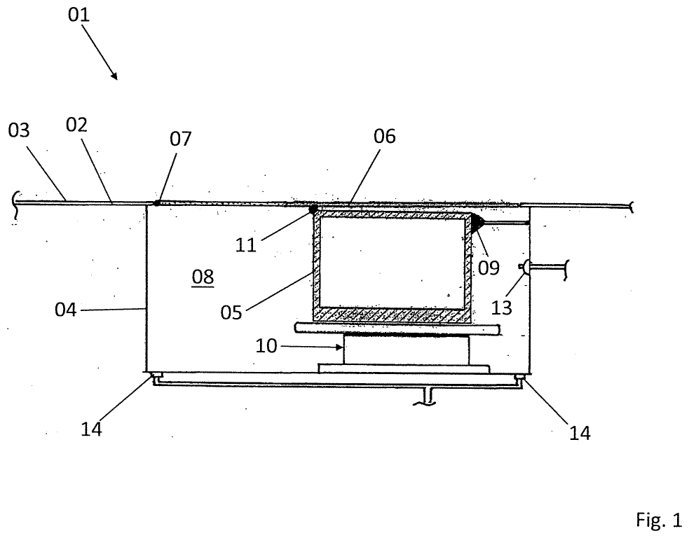

FIG. 1 is a schematic longitudinal section of a roof module with an environmental sensor in its inoperative position;

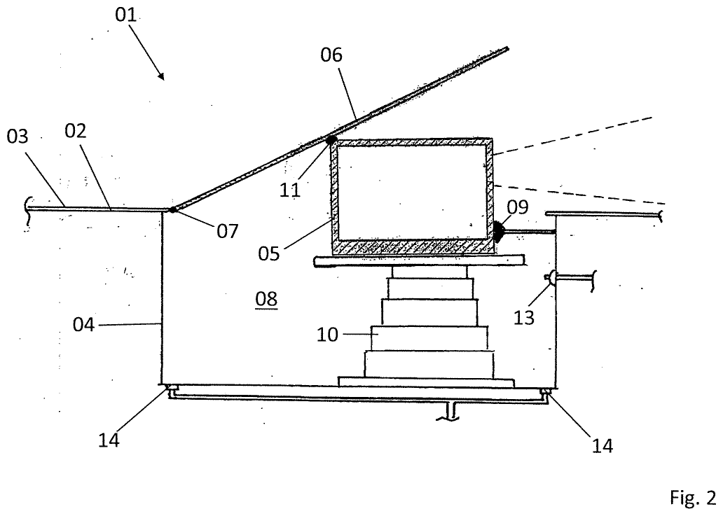

FIG. 2 shows the roof module of FIG. 1 after the environmental sensor has been moved into its operative position;

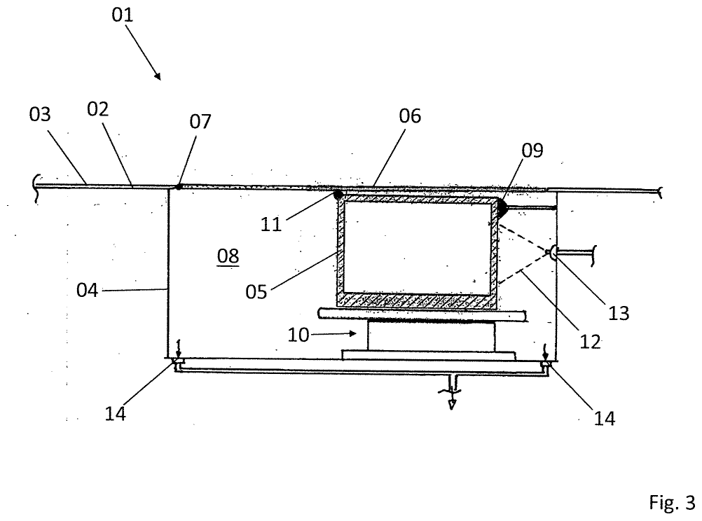

FIG. 3 shows the roof module of FIG. 1 during cleaning of the environmental sensor;

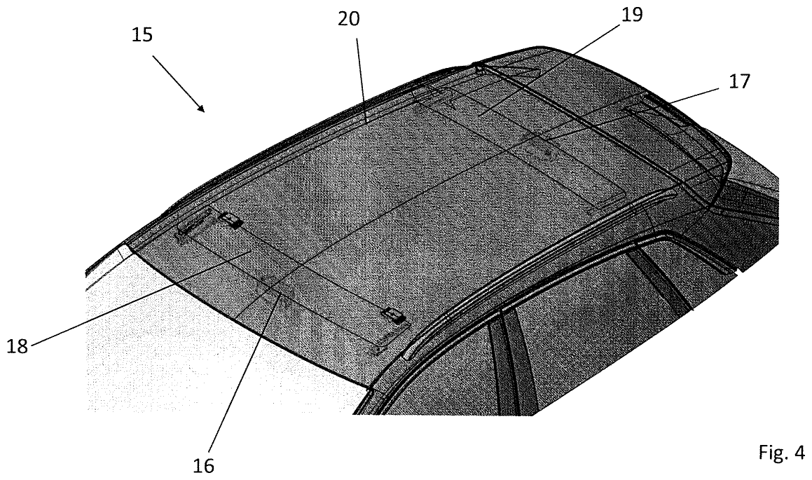

FIG. 4 is a perspective side view of a second embodiment of a roof module with two environmental sensors in the inoperative position;

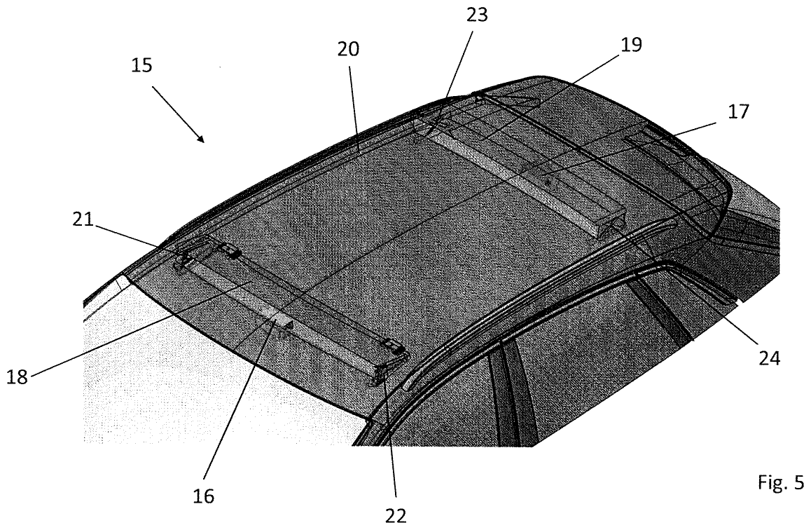

FIG. 5 is a perspective side view the roof module of FIG. 4 after the two environmental sensors have been moved into their operative position;

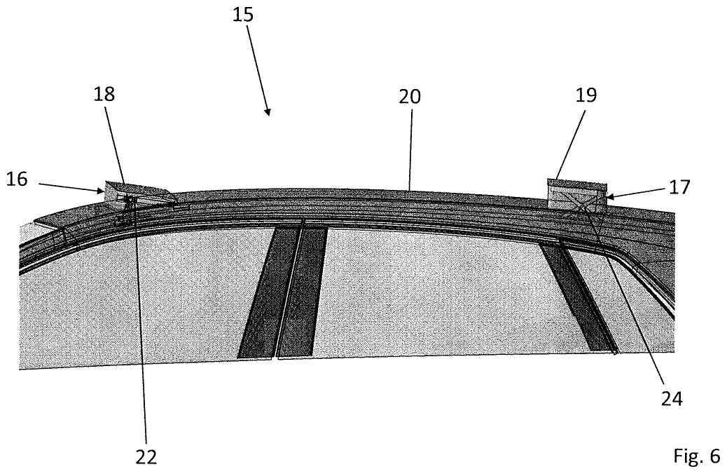

FIG. 6 is a side view of the roof module of FIG. 5 after the two environmental sensors have been moved into their operative position.

FIG. 1 show a section of a roof module 01 of a motor vehicle realized as a passenger vehicle, the roof module being illustrated in FIG. 1 only in so much detail as is needed to understand the invention. Roof module 01 comprises a panel component 02 whose outer surface forms the roof skin of a vehicle roof. A housing 04 in which an environmental sensor 05, such as a LiDAR sensor, is disposed is provided underneath roof skin 03, i.e., on the underside of panel component 02. In FIG. 1, environmental sensor 05 is in its inoperative position. In this inoperative position of environmental sensor 05, the upper opening of housing 04 is closed by means of a lid 06, resulting in a closed surface of roof skin 03. Lid 06 is mounted on panel component 02 in such a manner that it can pivot on a pivot axis 07 and can be pivoted open in the upward direction.

Moreover, a wiper element 09 is fixed in recess 08 accommodating environmental sensor 05. The effective surface of wiper element 09 is in contact with a visible surface of the outer surface of environmental sensor 05. A drive mechanism 10 by means of which the environmental sensor can be deployed from its inoperative position illustrated in FIG. 1 into its operative position illustrated in FIG. 2 is located below environmental sensor 05.

FIG. 2 shows roof module 01 after environmental sensor 05 has been deployed into its operative position. In this operative position, lid 06 is open and environmental sensor 05 protrudes beyond roof skin 03 to a degree in order to be able to detect the environment of the vehicle. Drive mechanism 10 has been extended upward to displace environmental sensor 05. When environmental sensor 05 is deployed, the movement relative to wiper element 09 results in a wiping motion across the surface to be wiped of environmental sensor 05, allowing any adhering dirt particles to be at least partially removed.

Environmental sensor 05 is attached to lid 06 via a joint 11, lid 06 thus being opened and closed by the positioning movement of environmental sensor 05.

FIG. 3 shows roof module 01 during cleaning of environmental sensor 05. To be cleaned, environmental sensor 05 is first moved into its inoperative position in recess 08 and lid 06 is closed in the process. Then, a cleaning fluid 12 is discharged by means of a cleaning nozzle 13 and sprayed onto the see-through area of environmental sensor 05. Undesired leakage of cleaning fluid 12 from recess 08 is precluded since lid 06 is closed. Instead, two drains 14 through which cleaning fluid 12 can be discharged downward in a controlled manner are provided at the bottom of housing 04.

FIG. 4 shows a second embodiment 15 of a roof module for forming a vehicle roof A front environmental sensor 16 and a rear environmental sensor 17, each of which is disposed in a recess of roof module 15, are provided on roof module 15. In FIG. 4, the two environmental sensors 16 and 17 are in their inoperative position, the recesses in roof module 15 being closed by a lid 18 and a lid 19, respectively. The two lids 18 and 19 each form part of roof skin 20 when environmental sensors 16 and 17 are in the inoperative position.

FIG. 5 shows roof module 15 after the two environmental sensors 16 and 17 have been displaced into their respective operative positions. Two lateral pivot drives 21 and 22, by means of which lid 18 and environmental sensor 16 disposed in the front can be pivoted upward, are provided for displacing front environmental sensor 16.

In contrast, two lateral scissor lifting drives 23 and 24, by means of which the entire lid can be lifted relative to roof skin 20, are provided for displacing rear environmental sensor 17 and lid 18.

FIG. 6 shows roof module 15 with environmental sensors 16 and 17 in their operative position. Pivoting drive 22 and scissor lifting drive 24 are visible.

### REFERENCE SIGNS

01 roof module
02 panel component
03 roof skin
04 sensor housing
05 environmental sensor
06 lid
07 pivot axis
08 recess
09 wiper element
10 drive mechanism
11 joint
12 cleaning fluid
13 cleaning nozzle
14 drain
15 roof module
16 environmental sensor
17 environmental sensor
18 lid
19 lid
20 roof skin
21 pivot drive
22 pivot drive
23 scissor lifting drive
24 scissor lifting drive

1. A roof module for forming a vehicle roof on a motor vehicle, the roof module comprising:
a panel component whose outer surface forms at least a portion of the roof skin of the vehicle roof,
the roof module comprising at least one environmental sensor which can send and/or receive electromagnetic signals to detect the vehicle environment,
wherein the environmental sensor is mounted on the roof module in such a manner that it can be displaced between an inoperative position and an operative position, the environmental sensor being displaceable between the inoperative position and the operative position by a drive mechanism.

2. The roof module according to claim 1, wherein the roof module comprises at least one sensor housing in which the environmental sensor is disposed, the sensor housing having a recess which accommodates the environmental sensor in the inoperative position.

3. The roof module according to claim 2, wherein the recess can be closed by a lid mounted in a displaceable manner when the environmental sensor is in the inoperative position, the environmental sensor being moved out of the recess when in the operative position.

4. The roof module according to claim 3, wherein the sensor housing is disposed underneath the roof skin, the lid, which is closed when the environmental sensor is in the inoperative position, forming a portion of the roof skin.

5. The roof module according to claim 4, wherein the lid is mounted to pivot on the roof module, the pivot axis extending in the plane of the roof skin.

6. The roof module according to claim 1, wherein the drive mechanism is a pivot drive.

7. The roof module according to claim 1, wherein the drive mechanism is a lifting drive.

8. The roof module according to claim 1, wherein a wiper element by which a portion of the outer surface of the environmental sensor can be wiped, is disposed in the sensor housing.

9. The roof module according to claim 8, wherein the wiper element is fixed in the sensor housing, the wiper element being in contact with the portion to be wiped of the outer surface of the environmental sensor.

10. The roof module according to claim 1, wherein a heating means and/or a cooling means by which the environmental sensor can be heated and/or cooled is provided in the sensor housing.

11. The roof module according to claim 1 wherein the environmental sensor is at least one of a lidar sensor, a radar sensor, a camera sensor, and a multi-camera sensor.

12. The roof module according to claim 1, wherein at least one cleaning nozzle which can discharge a cleaning fluid for cleaning the environmental sensor is disposed in the sensor housing.

13. The roof module according to claim 11, wherein a drain through which the cleaning fluid can be discharged from the sensor housing is provided in the sensor housing.

14. A method for operating a roof module according to claim 12, wherein the cleaning fluid is discharged to clean the environmental sensor when the environmental sensor is in the inoperative position and the lid above the recess of the sensor housing is closed.

15. A motor vehicle comprising a roof module according to claim 1.

16. The roof module according to claim 7, wherein the lifting drive is a scissor lifting drive.
